(19) United States
(12) Patent Application Publication
(10) Pub. No.: US 2011/0115177 A1
(43) Pub. Date: May 19, 2011

(54) TRANSPORTATION CART

(76) Inventor: Rogério Luiz de Sousa, Florianopolis (BR)

(21) Appl. No.: 12/758,088

(22) Filed: Apr. 12, 2010

(30) Foreign Application Priority Data
Nov. 18, 2009 (BR) 017090001780

(51) Int. Cl. B62B 3/02; B62B 5/08

(52) U.S. Cl. 280/47.35; 280/79.3; 280/47.38

(57) ABSTRACT

A transportation cart having three movable platforms for the transportation of products and/or boxes, enabling the consumer to replace the use of plastic bags by cardboard boxes, which can be recycled and reused thus reducing environmental harm caused by regular packaging.

### FIELD OF THE INVENTION

The invention refers to a cart with movable horizontal platforms for the transportation of products and/or goods.

### BACKGROUND OF THE INVENTION

Nowadays, carts are constituted of one high and deep basket which prevents a proper organization of products, frequently smashing them on top of each other. Obtaining a product from the bottom of a full basket might be difficult at times. Traditional carts were developed for storage of plastic bags with extended life not to mention that it takes several years in order for them to decompose.

The transportation cart of the present invention was developed in order to allow usage of cardboard boxes for the transportation of goods and/or products.

### SUMMARY OF THE INVENTION

The present invention seeks to provide a transportation cart comprising: (a) a first substantially angled double L-shaped frame having a long horizontal section with an edge and a short vertical section with an edge, the long section having a rear and a frontal area; (b) a double I-shaped rod extending from the long horizontal section of the angled L-shaped frame and connected substantially half way to the short vertical section of the substantially angled L-shaped frame by a horizontal short rod; (c) four rotating casters attached to the long horizontal section of the substantially angled double L-shaped frame; (d) a first platform attached to the double I-shaped rod at one extremity; a second platform attached to edge of the short vertical section of the substantially angled double L-shaped frame; and a third platform attached to edge of the long horizontal section of the substantially angled double L-shaped frame, the platform resting on the long horizontal section of the substantially angled double L-shaped frame and is able to be tilted upwardly at the opposite end within a limited angle, all platforms are of same lengths and parallel to each other in a rest position; (e) a first axis connecting the first platform to the double I-shaped rod and a second axis connecting the second platform to the edge of the short vertical section of the substantially angled double L-shaped frame, the first axis enabling a 270 degree rotation of the first platform and the second axis enabling the tilting of the second platform within a limited angle; and (f) a basket, the basket able to be used as a small children's seat.

### BRIEF DESCRIPTION OF THE DRAWINGS

FIG. 1 shows a side view of the transportation cart.

FIG. 2 shows a frontal view of the transportation cart.

FIG. 3 shows a side view in perspective of the transportation cart.

FIG. 4 shows a side view in perspective of the transportation cart with the platforms in rest.

FIG. 5 shows a side view in perspective of the transportation cart with the possible vertical movements of the platforms.

FIG. 6 shows a side view in perspective of the transportation cart with the platform A.1 opened entirely at a 270 degrees angle whereas the other platforms remain in a rest position.

FIG. 7 shows a side view in perspective of the transportation cart with the first platform open entirely at a 270 degrees whereas the other platforms remain in a rest position.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The cart has three movable platforms for the transportation of products and/or boxes. This new configuration enables the consumer to replace the use of plastic bags by cardboard boxes, which can be recycled and reused thus reducing environmental harm caused by regular packaging.

The cart comprises of a substantially angled double L-shaped frame (F1) having a long horizontal section with an edge and a short vertical section with an edge, the long section having a rear and a frontal area. The cart also includes a double I-shaped rod (I1) extending from the long horizontal section of the angled L-shaped frame and connected substantially half way to the short vertical section of the substantially angled L-shaped frame by a horizontal short rod (H1).

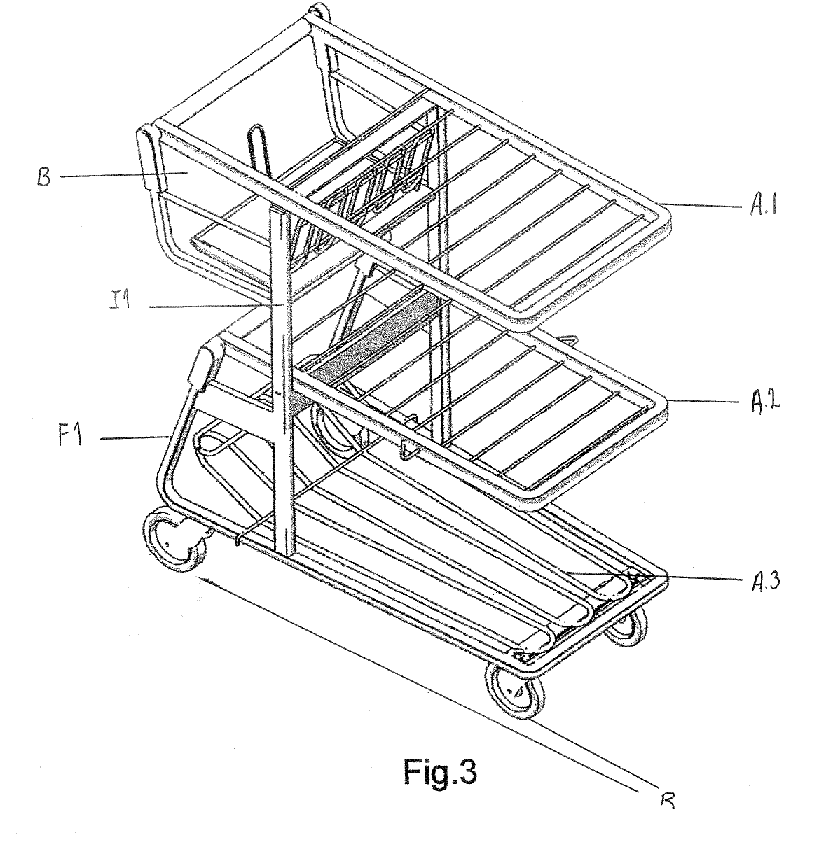

The cart further comprises of four casters (R)(FIG. 3) that rotate in a vertical axis making it easier to maneuver the cart between the narrow aisles of the stores and supermarkets.

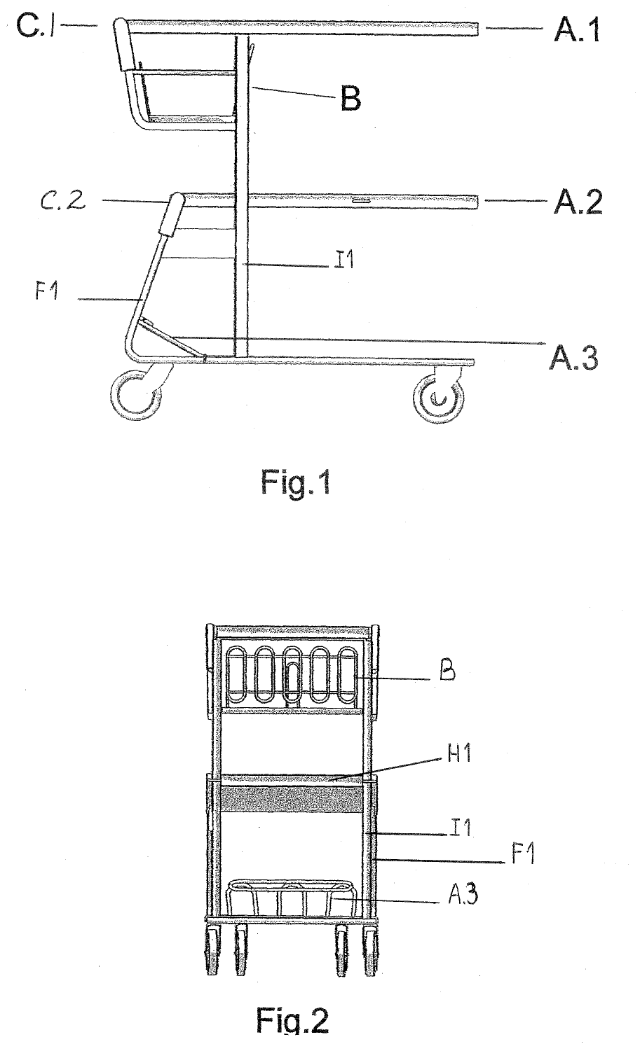

FIG. 1 displays the cart as having three platforms: a first high platform (A.1) that can rotate 270 degrees upwardly at the (C.1) axis (as illustrated in FIG. 7), a second intermediate platform (A.2) that can tilt upwardly at the (C.2) axis and a third lower platform (A.3). The front edges of the three platforms are round in order to facilitate the nesting of the carts as well as sliding them easily into each other.

In FIG. 2 a frontal view of the cart is seen, showing the spaces and alignment of the platforms and frames.

FIG. 3 shows a side view in perspective of the cart when it is at rest displaying all three platforms of the cart (A.1), (A.2) and (A.3), the basket (B) and the four casters (R) facilitating the movement of the cart.

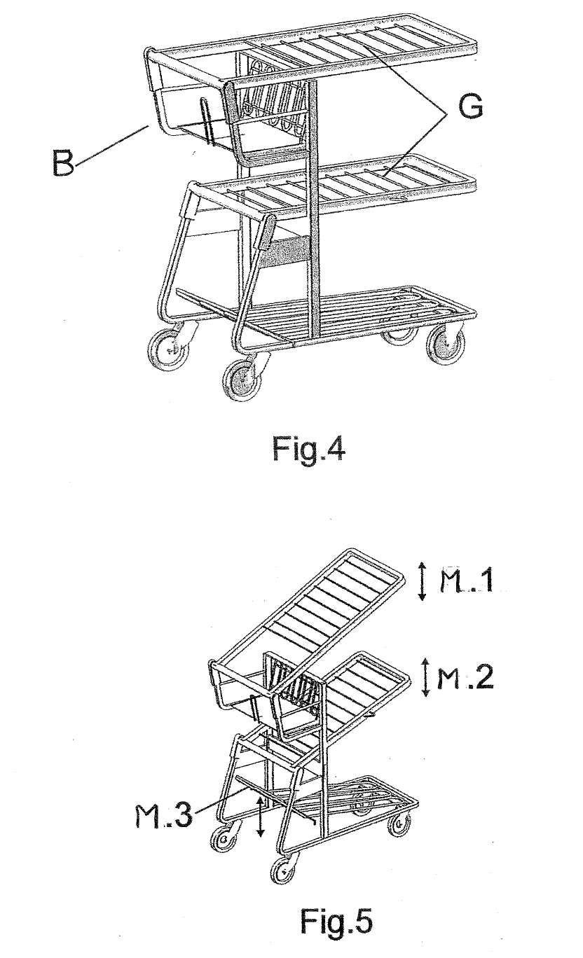

FIG. 4 shows the multiple parallel rods (G) on the first and second platform. Their configuration provides the necessary space to safely fit the neck of a twenty (20) liter water bottle.

FIGS. 5 shows a side view in perspective of the cart identifying the upward movements (M.1) and (M.2) of the first and second platforms. The vertical movement of the third platform is represented by (M.3).

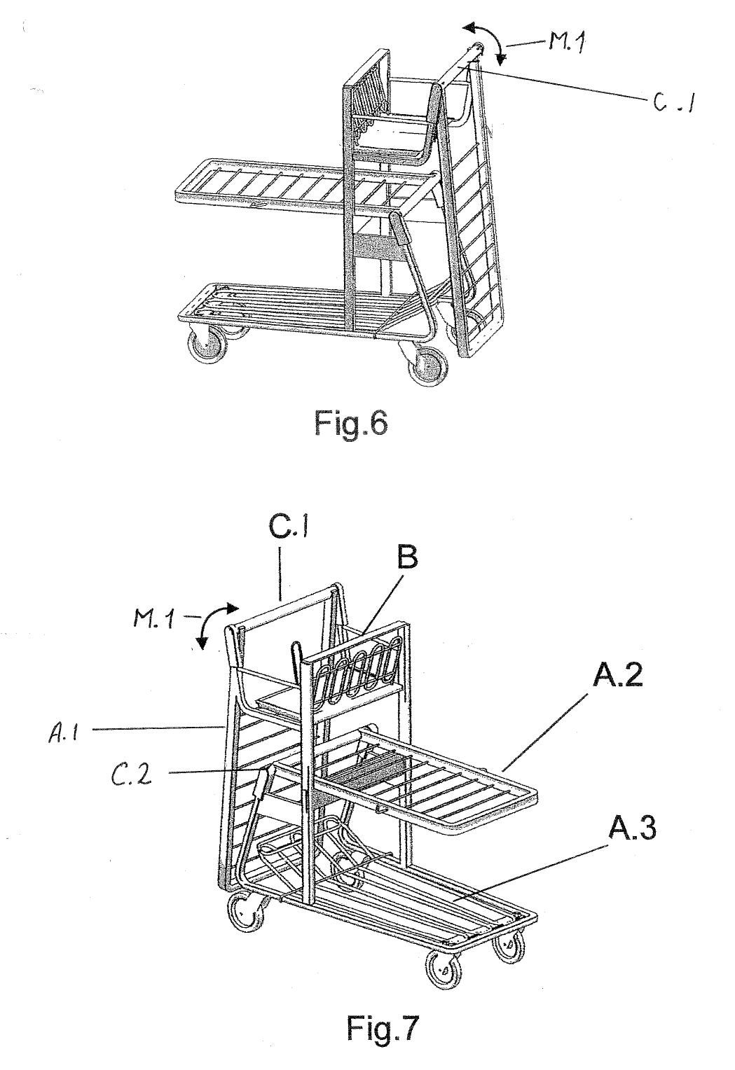

FIG. 6 shows the 270 degrees rotation (M.1) of the first platforms(A.1) around the C.1 axis.

FIG. 7 shows a side view in perspective with the platform (A.1) rotated entirely at a 270 degrees angle around the (C.1) axis. Platforms (A.2) and (A.3) are at rest.

Although not shown in the figures, the cart of the present invention can also be equipped with the new Radio Frequency Identification System (“RFID”). The RFID is a technology using electromagnetic waves to access data stored in a microchip placed on the goods, objects and/or products. This system reads the products' data without having to pass the product over a bar code reader. When the cart passes through the cash, the adhesive chip goes through the cashier's radio frequency field allowing the system to automatically calculate the total amount of the purchase.

1. A transportation cart comprising:
(a) a first substantially angled double L-shaped frame having a long horizontal section with an edge and a short vertical section with an edge, the long section having a rear and a frontal area;
(b) a double I-shaped rod extending from the long horizontal section of the angled L-shaped frame and connected substantially half way to the short vertical section of the substantially angled L-shaped frame by a horizontal short rod;
(c) four rotating casters attached to the long horizontal section of the substantially angled double L-shaped frame;
(d) a first platform attached to the double I-shaped rod at one extremity; a second platform attached to edge of the short vertical section of the substantially angled double L-shaped frame; and a third platform attached to edge of the long horizontal section of the substantially angled double L-shaped frame, the platform resting on the long horizontal section of the substantially angled double L-shaped frame and is able to be tilted upwardly at the opposite end within a limited angle, all platforms are of same lengths and parallel to each other in a rest position;
(e) a first axis connecting the first platform to the double I-shaped rod and a second axis connecting the second platform to the edge of the short vertical section of the substantially angled double L-shaped frame, the first axis enabling a 270 degree rotation of the first platform and the second axis enabling the tilting of the second platform within a limited angle, and
(f) a basket, the basket able to be used as a small children's seat.

2. The transportation cart, according to claim 1, wherein the first platform is easily rotated around the axis and the second platform is easily tilted upwardly around the axis enabling the removal or the display of objects and/or products from the platforms.

3. The transportation cart, according to claim 1, wherein the platforms further include front edges, the front edges of the platforms being round.

4. The transportation cart, according to claim 1, wherein the platforms comprise multiple parallel rods

5. The transportation cart, according to claim 3, wherein the platforms are suitable for carrying a twenty-liter water bottle.
